(19) United States
(12) Patent Application Publication
(10) Pub. No.: US 2025/0139840 A1
(43) Pub. Date: May 1, 2025

(54) BOOK INFORMATION PROCESSING METHOD AND APPARATUS, DEVICE, AND STORAGE MEDIUM

(71) Applicant: Beijing Zitiao Network Technology Co., Ltd., Beijing (CN)

(72) Inventors: Xingwen Zhang, Beijing (CN); Chuanqi Jing, Beijing (CN)

(21) Appl. No.: 18/793,354

(22) Filed: Aug. 2, 2024

(30) Foreign Application Priority Data
Oct. 27, 2023 (CN) 202311415793.9

(51) Int. Cl. G06T 11/00; G06F 3/0483

(52) U.S. Cl. CPC G06T 11/00; G06F 3/0483

(57) ABSTRACT

Embodiments of the present disclosure relate to a book information processing method and apparatus, a device, and a storage medium. The method includes: displaying, on a character details page corresponding to a target character, a first character card corresponding to the target character and first book content when the target character is at a first book stage, wherein the first character card is generated based on the first book content; and the first character card is one of a plurality of character cards corresponding to the target character; and in response to a target interactive operation on the first book content, displaying a reading page of a target book in which the target character is located, and displaying second book content of the target book on the reading page.

### CROSS-REFERENCE TO RELATED APPLICATION(S)

This application claims priority to Chinese Application No. 202311415793.9 filed Oct. 27, 2023, the disclosure of which is incorporated herein by reference in its entirety.

### FIELD

The present disclosure relates to the technical field of electronic books, and in particular, to a book information processing method and apparatus, a device, and a storage medium.

### BACKGROUND

Currently, with the popularity of mobile terminal devices, electronic books are becoming increasingly popular. In order to improve the efficiency of book selection, book reading applications may select some books that may be of interest to users from a large number of books and then recommend them to the users. The users may select a book, enter a book details page, and jump to a corresponding reading page to read book content, so as to determine whether the selected book is of their interest.

However, the above book recommendation method and book reading switching method may easily cause low efficiency of book selection, thus resulting in a low reading conversion rate of the recommended book.

### SUMMARY

In order to solve the above technical problem, embodiments of the present disclosure provide a book information processing method and apparatus, a device, and a storage medium.

According to a first aspect, an embodiment of the present disclosure provides a book information processing method. The method includes:
displaying, on a character details page corresponding to a target character, a first character card corresponding to the target character and first book content when the target character is at a first book stage, wherein the first character card is generated based on the first book content; and the first character card is one of a plurality of character cards corresponding to the target character; and
in response to a target interactive operation on the first book content, displaying a reading page of a target book in which the target character is located, and displaying second book content of the target book on the reading page.

According to a second aspect, an embodiment of the present disclosure further provides a book information processing apparatus. The apparatus includes:
a first character card display module configured to display, on a character details page corresponding to a target character, a first character card corresponding to the target character and first book content when the target character is at a first book stage, wherein the first character card is generated based on the first book content; and the first character card is one of a plurality of character cards corresponding to the target character; and
a second book content display module configured to, in response to a target interactive operation on the first book content, display a reading page of a target book in which the target character is located, and display second book content of the target book on the reading page.

According to a third aspect, an embodiment of the present disclosure further provides an electronic device. The electronic device includes:
a processor; and
a memory configured to store executable instructions,
where the processor is configured to read the executable instructions from the memory, and execute the executable instructions to implement the book information processing method illustrated in any embodiment of the present disclosure.

According to a fourth aspect, an embodiment of the present disclosure further provides a computer-readable storage medium storing a computer program, where the computer program, when executed by a processor, causes the processor to implement the book information processing method illustrated in any embodiment of the present disclosure.

According to a fifth aspect, an embodiment of the present disclosure further provides a computer program product for performing the book information processing method illustrated in any embodiment of the present disclosure.

In the book information processing method and apparatus, the device, and the storage medium of the embodiments of the present disclosure, the first character card of the plurality of character cards corresponding to the target character and the first book content when the target character is at the first book stage can be displayed on the character details page corresponding to the target character. The first character card is generated based on the first book content. More information about the recommended target character at the first book stage is displayed through the character details page, which improves the content and diversity of information about the recommended character. In addition, by displaying the first book content on the character details page, content in the body of the book corresponding to the first character card is revealed in advance, so that a user may browse the character details page to determine whether they want to continue reading the target book in which the recommended character is located, thereby improving the efficiency of book selection, the success rate of recommending books in a character dimension, and the reading conversion rate of books. In addition, in response to the target interactive operation on the first book content, the reading page of the target book may be displayed, and the second book content of the target book may be displayed on the reading page, which makes it possible to directly jump to the reading page to read the book content through the interactive operation on the first book content on the character details page, improving the immersion of a jump to reading, and shortening the operation path from recommendation information on the book to the reading page, thereby further improving the reading conversion rate of the recommended book.

### BRIEF DESCRIPTION OF THE DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic flowchart of a book information processing method according to an embodiment of the present disclosure;

FIG. 2 is a schematic diagram of display of a target character card displayed on a specific page according to an embodiment of the present disclosure;

FIG. 3 is a schematic diagram of display of a character details page according to an embodiment of the present disclosure;

FIG. 4 is a schematic diagram of display of another character details page according to an embodiment of the present disclosure;

FIG. 5 is a schematic diagram of display of a reading jump prompt displayed on a character details page according to an embodiment of the present disclosure;

FIG. 6 is a schematic diagram of display of a reading page according to an embodiment of the present disclosure;

FIG. 7 is a schematic flowchart of another book information processing method according to an embodiment of the present disclosure;

FIG. 8 is a schematic diagram of display of reading guidance information displayed on a character details page according to an embodiment of the present disclosure;

FIG. 9 is a schematic diagram of a structure of a book information processing apparatus according to an embodiment of the present disclosure; and

FIG. 10 is a schematic diagram of a structure of an electronic device according to an embodiment of the present disclosure.

### DETAILED DESCRIPTION OF EMBODIMENTS

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

Book reading applications may recommend to users books that match their reading interests. However, such a book recommendation method mainly focuses on recommendation of book information with limited information content, and has a limited effect on motivating a user to read a recommended book, resulting in a low reading conversion rate of the recommended book. In addition, when the user determines whether they would like to read the recommended book, they need to enter a book details page through an interactive operation due to limited information of the book, then enter a reading page by performing an interactive operation on a reading entry displayed on the book details page, and finally read part of the book content on the reading page, to determine whether they would like to read the book. Such a book selection process is complex and includes a long operation path for the user, resulting in low efficiency of book selection and a low reading conversion rate of the recommended book.

In view of this, an embodiment of the present disclosure provides a book information processing solution, which allows the recommendation of a book in a dimension of character information when characters contained in a book are at different book stages, to make the recommendation information on the book more interesting and informative, thereby improving the success rate of recommending books and the reading conversion rate of books. Moreover, part of book content corresponding to the character information can be displayed on the character details page so that the user determines whether the recommended book is of their interest based on the part of book content, which improves the efficiency of book selection. In addition, it is possible to seamlessly jump to the reading page of the book to read the full book through the interactive operation on part of the book content displayed on the character details page, which improves the efficiency of book reading.

The book information processing method according to the embodiment of the present disclosure is applicable in scenarios where electronic books are recommended to a book reading application and/or electronic books are read. The method may be performed by a book information processing apparatus, where the apparatus may be implemented by software and/or hardware and may be integrated into an electronic device with a display function. The electronic device may include, but is not limited to, mobile terminals such as a smart phone, a notebook computer, a personal digital assistant (PDA), a tablet personal computer (Tablet PC), a vehicle-mounted terminal (such as a vehicle navigation terminal), a wearable device, and fixed terminals such as a digital television and a desktop computer.

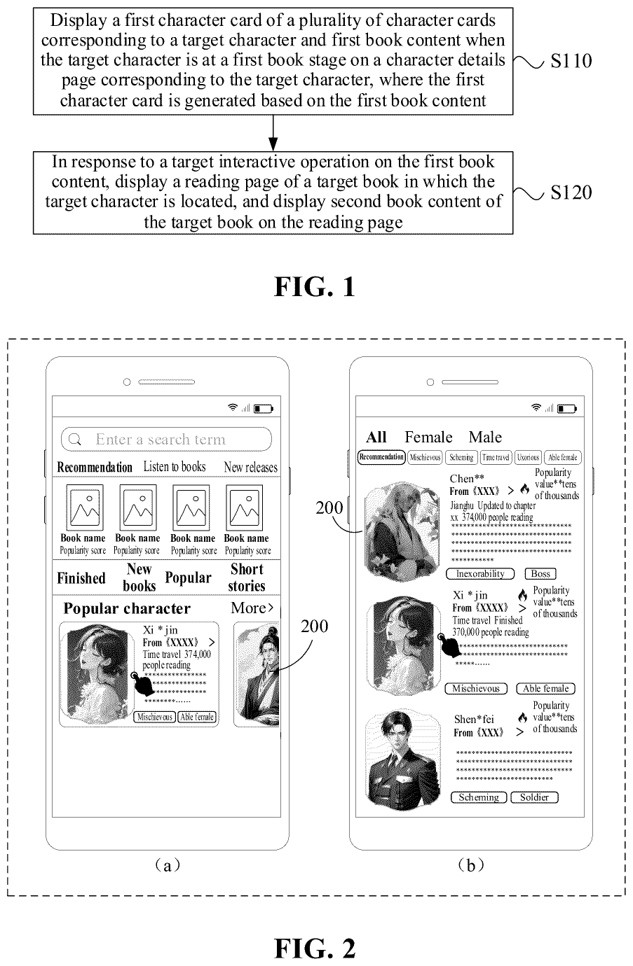

FIG. 1 is a schematic flowchart of a book information processing method according to an embodiment of the present disclosure. As shown in FIG. 1, the book information processing method may include the following steps.

In S110, a first character card of a plurality of character cards corresponding to a target character and first book content when the target character is at a first book stage are displayed on a character details page corresponding to the target character, where the first character card is generated based on the first book content.

The target character is a character involved in book content of a book (i.e., a target book) to be recommended to a user. The character details page is a page that records more detailed information about the target character. The character card is a visual card used to display character information of the target character. The first character card is one of the plurality of character cards corresponding to the target character. The character card may be used to present the character information of the target character. The character information includes at least one of a character image, a character profile, and book information of the target book. The character image is an image used to characterize the image of a character, which may be an image preset based on a character in a book, or may be an image automatically generated based on information related to the character. The character profile is a brief introduction to the target character, which may be, for example, words that are related to the target character in the book, an important plot related to the target character, or a summary generated based on various pieces of content of the book that are related to the target character, etc. The book information is a description of basic information of the book, which may be, for example, a book name, a book type, information indicating whether the book is finished or an update progress, and reading popularity of the book, etc.

The book stage is a stage at which the information about the book develops in a certain dimension. The dimension here may be, for example, a dimension indicating the user's reading progress over a historical period of time (i.e., a historical reading progress), an update dimension indicating an author's update to the book content, or a dimension indicating the progress of the target character's plot development in the book content, etc. The first book stage is one of a plurality of book stages. For example, the first book stage includes at least one of a book stage corresponding to a first reading progress in historical reading progresses, a book stage corresponding to a first update node in book content update nodes, and a book stage corresponding to a first development node in plot development nodes of the target character. If the user has historical reading progresses for the target book, a book stage corresponding to one of the historical reading progresses may be used as the first book stage, so as to recommend to the user later the first character card corresponding to the book content that they have read, which increases the probability of the user continuing reading the book and the success rate of recommending the book. If the target book is a book that is being serialized and whose content has not been updated completely, one of the plurality of book update nodes may be used as the first book stage so that the user may continue reading updated book content through the recommended first character card, which increases the probability of the user continuing reading the book and the success rate of recommending the book. If the book content of the target book contains a plurality of plot development nodes of the target character, for example, the book content contains plots of the target character in adolescence, youth, middle age, and old age, any one of these periods may be used as a plot development node so that the user may locate the plot of the target character in the corresponding period through the recommended first character card, which increases the probability of the user continuing reading the book and the success rate of recommending the book. It can be understood that the first book stage may also be a book stage corresponding to a node in any of the above cases so that an improved path for locating the corresponding book content through the recommended first character card is provided, thereby improving the success rate of recommending the book.

The first book content is book content of the target book that corresponds to the first book stage.

Specifically, an electronic device may display, on a specific page of a reading application, a plurality of character cards to be recommended to the user, and the character cards contain the first character card of the target character when at the first book stage. In order to enhance the degree of revealing the first book content by the first character card, the first book content may be used as basic data to generate the first character card by means of a generative model.

The above specific page may be, for example, a book recommendation page, a discussion community/book circle page corresponding to a book, a book results page generated after searching for a certain book, or a character select page for displaying at least one type of character, etc.

When the user selects the first character card on the specific page, the electronic device may jump from the specific page to a character details page of the first character card in response to the selection operation. Then, complete character information of the target character corresponding to the first character card is displayed on the character details page, which solves the problem of incomplete display of information about the target character on the specific page due to a limited card area. Moreover, in order to improve the efficiency of book selection, according to the embodiment of the present disclosure, at least part of the book content, i.e., the first book content, may be revealed in advance on the character details page, so that the user can directly learn about the book content when the target character is at the first book stage without jumping to the reading page for reading complete book content. This allows the user to determine whether to continue reading the book directly through the character details page, avoiding the need for the user to perform more interactive operations before completing book selection.

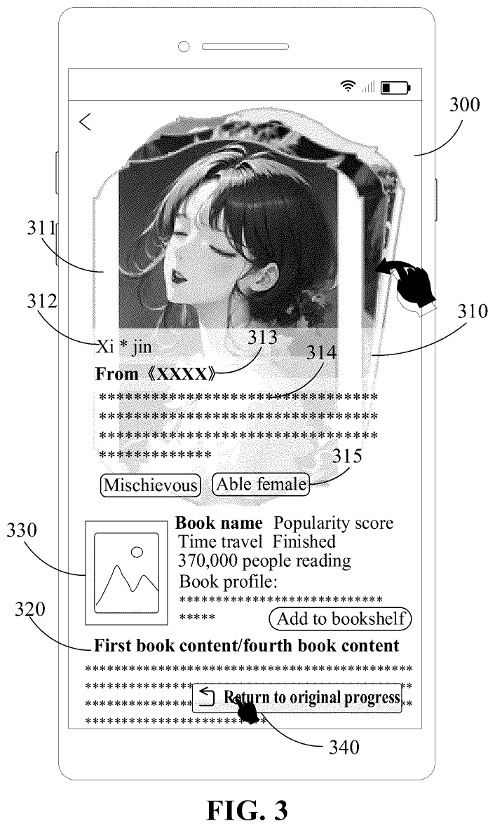

For example, a plurality of character cards 200 are displayed on a book recommendation page of FIG. 2(a), and a plurality of character cards 200 may also be displayed on a character selection page of FIG. 2(b). The user may perform a trigger operation on any character card on any page. In response to the trigger operation, the electronic device may jump to display the character details page, as shown in FIG. 3. In FIG. 3, the electronic device may display a first character card 310 of the target character on a character details page 300. The first character card 310 includes a character image 311, a character name 312, a character profile 314, a character tag 315, and a book name 313. Since character information of the first character card is displayed in a larger card area, more complete character information may be displayed in the card area. For example, the first character card on the book recommendation page or the character selection page in FIG. 2 may not present a complete character profile, whereas the first character card on the character details page 300 may present a complete character profile 314. Moreover, first book content 310 corresponding to the target character may further be displayed on the character details page 300.

It should be noted that a book information block 330 may further be displayed on the character details page 300. Basic book information, a book profile, and a control for adding to a bookshelf, etc. may be displayed in the book information block 330, to further improve information about the book contained on the character details page. The above book profile is a brief introduction to the book content, for example, information indicating a reason for recommending the book, a description of a main story line of the book, a description of characters and their relationships in the book, etc.

In some embodiments, the target character is determined from a plurality of candidate characters contained in the target book based on a character popularity value and a target character type. The target book is determined from a plurality of candidate books based on a book popularity value and a target book type.

The character popularity value is a numerical indicator value that characterizes the popularity of a character in the book. The character popularity value may be determined based on popularity of discussion on the character and/or reading popularity of the book corresponding to the character. The discussion popularity here may be characterized by at least one of the following indicators: the number and quality of comments on the character, the number and quality of character discussion posts posted by the user with respect to the character, the amount of interactions (such as likes and shares) for the above comments and/or character discussion posts, and the reading conversion rate of reading the corresponding book based on the character discussion posts or the character cards displayed in the embodiments of the present disclosure, etc. The reading popularity here may be characterized by at least one of the number of users who read the book, the number of hours spent reading the book, the number of days users are active, etc. The target book type is a type of book that the user is interested in. For example, if the user is interested in a “time travel” type of book, the target book type may be “time travel”. The target book type may be determined by the type of books that the user have read within the historical period of time, or may be determined by a preferred book type entered by the user himself/herself.

Specifically, firstly, the target book may be selected from the plurality of candidate books based on the book popularity value and the target book type; and then, based on character popularity values and target character types of the plurality of candidate characters involved in the target book, the target character may be selected from the above candidate characters. In this way, the recommendation success rate of the recommended character card can be improved, and then the reading conversion rate of the target book corresponding to the recommended character can be improved.

In some other embodiments, the target character is determined from the plurality of candidate characters based on a character popularity value and a target character type. The target character may be selected from a plurality of candidate characters contained in a plurality of books directly based on the character popularity value and the target character type, and then the target book may be located based on the target character.

In some embodiments, the first character card includes a first character image of the target character, the first character image is generated based on the first book content and a target image style, and the target image style is determined based on interactive data of character images selected in a historical period of time.

Specifically, the character information in the first character card may contain the character image corresponding to the first book stage (i.e., the first character image). The first character image may be generated based on the content in the first book content that describes the character, to ensure that the first character image has a high degree of fit with the character image of the target character at the first book stage, so that the target character at the corresponding book stage may be more intuitively and vividly displayed through the first character image.

On this basis, in order to make the first character image more in line with personalized needs of the user, the first character image may be optimized in combination with information of character images in character cards selected by the user within the historical period of time. For example, character images selected by the user within the historical period of time may be collected, and then sorted according to interactive data of the character images (such as a click-through rate of a character image and the reading conversion rate of the corresponding book), and the image style of the character image that are sorted first is determined as a desired image style for optimization. Finally, the image style corresponding to the content in the first book content that describes the target character is combined with the desired image style for optimization determined above, and then combined with text content in the first book content that describes the target character, to generate an optimized first character image by means of the generative model.

It should be noted that the character profile in the character information may also be automatically generated based on the first book content by means of the generative model.

It should also be noted that a model structure of the generative model in the embodiments of the present disclosure may not be limited, as long as it is trained to have a function of generating an image based on an image style and related text content, and/or to have a function of generating a character profile based on related text content.

In S120, in response to a target interactive operation on the first book content, a reading page of a target book in which the target character is located is displayed, and second book content of the target book is displayed on the reading page.

The target interactive operation is an interactive operation corresponding to the function for triggering an immersive/seamless page jump, and is set at least based on the first book content. For example, the target interactive operation may be a browsing operation on the book content, or a trigger operation on a function control corresponding to the first book content, etc. The immersive/seamless page jump function here may be understood as a function of automatically performing a page jump during the process of the user browsing a page without requiring the user to specifically locate to a page entry control of a certain page and perform a trigger operation on the page entry control. The second book content is at least part of the content of the target book, which may be the same as or different from the first book content.

Specifically, in order to improve the immersion of book reading and reduce the cost of user's interactive operations, a function of making a seamless jump from the character details pages to the reading page of the book may be provided in the embodiments of the present disclosure. In this way, when the user performs the target interactive operation (e.g., clicking, browsing, etc.) corresponding to the function of seamlessly jumping to the reading page on the first book content, the electronic device may automatically jump from the character details page to the reading page of the book in response to the target interactive operation. The second book content of the target book is then displayed on the reading page so that the user may read the book in its entirety.

In some embodiment, the second book content may be book content in a first chapter of the target book. In this way, after reading the first book content on the character details page, the user may start reading the target book from the first chapter of the target book on the reading page, which improves the completeness of the user's reading of the book.

In some other embodiments, the second book content may be book content that follows the first book content and is continued from the first book content. For example, when the first book content is book content corresponding to the most recent historical reading progress, the user may review the book content corresponding to the most recent historical reading progress through the first book content displayed on the character details page, and then when a jump is made to the reading page, the user may continue reading subsequent book content without having to read the same book content repeatedly, thereby further improving the user's efficiency in reading books.

In some embodiments, the process of implementing a seamless page jump in S120 includes: displaying a progress jump control in a first set area corresponding to the first book content if it is determined that there is a corresponding historical reading progress for the target book; determining book content corresponding to the historical reading progress as the second book content in response to a trigger operation on the progress jump control; and displaying the reading page and displaying the second book content on the reading page.

The historical reading progress is a reading progress for the reading of a book over a period of time preceding a current moment (referred to as the historical period of time). The reading progress may be characterized by a proportion of read content in the entire book content, or by read paragraphs in read chapters, etc. If there are a plurality of historical reading progresses, the most recent historical reading progress may be selected. The first set area is a display sub-area of an area, where the first book content is displayed, on the character details page, for example, a middle area where the user focuses their eyes on, or a peripheral area such as the top or bottom of the area where the first book content is displayed. The progress jump control is an interactive control for controlling a return to book content corresponding to the historical reading progress.

Specifically, if the user has ever read the target book, a corresponding historical reading progress is recorded. Therefore, when the historical reading progress obtained by the electronic device is not empty, it is determined that the user has a corresponding historical reading progress for the target book. At this point, the progress jump control may be displayed in the first set area corresponding to the first book content. As shown in FIG. 3, the progress jump control 340 with text content “Return to original progress” may be displayed in the bottom area of the screen where the first book content is located. Then, if the electronic device detects the user's trigger operation on the progress jump control 340, a jump is made to the reading page and the book content corresponding to the historical reading progress is located, and the located book content is displayed on the reading page as the second book content. In this way, when the user has ever read the book, the user can make a seamless jump to the reading page to continue reading the book content without having to browse too much the first book content on the character details page, which further improves the efficiency of book reading and the user experience.

In some embodiments, after browsing the character details page until a jump is made to the reading page to display the second book content, the book information processing method further includes: displaying the progress jump control in a second set area corresponding to the second book content if it is determined that there is a corresponding historical reading progress for the target book; and displaying the book content corresponding to the historical reading progress on the reading page in response to the trigger operation on the progress jump control.

Specifically, in the case of an automatic jump from the character details page to the reading page to display the second book content, in order to further improve the efficiency of book reading and the user experience, the electronic device may query whether the user's historical reading progress for the target book is empty. If the user's historical reading progress for the target book is empty, no further processing is performed. If the user's historical reading progress for the target book is not empty, indicating that the user has ever read the target book, the progress jump control may be displayed in a certain set area (i.e., the second set area) in a display area of the reading page.

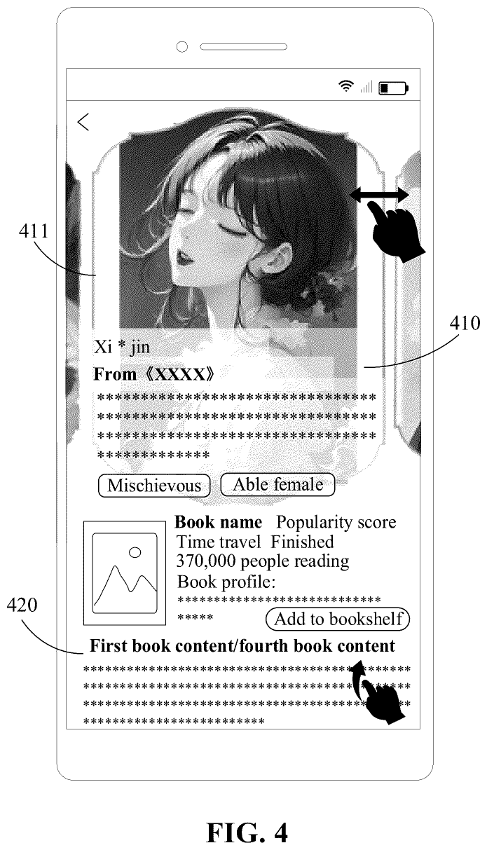

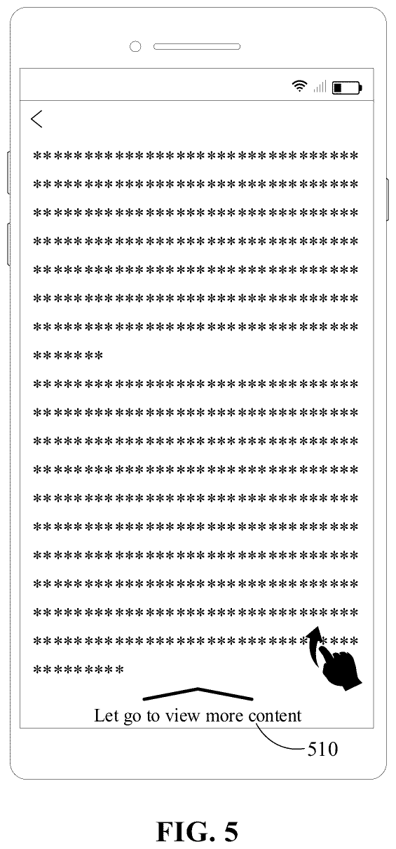

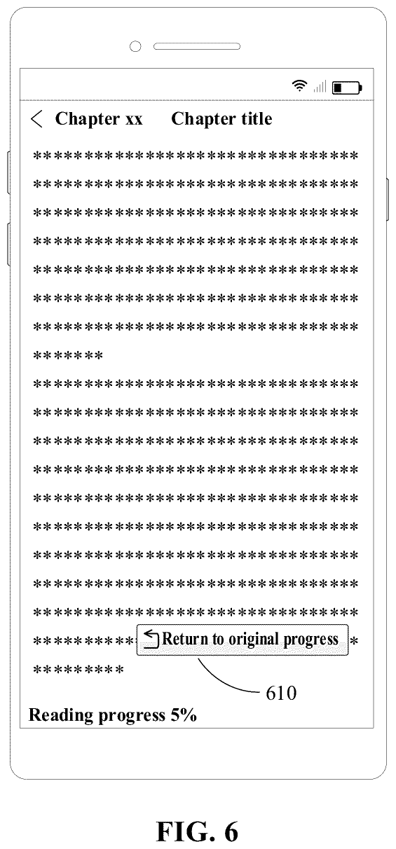

Referring to the examples in the above embodiments, when the electronic device changes from browsing the character details page shown in FIG. 4 to browsing the character details page shown in FIG. 5, and makes an automatic jump to the reading page shown in FIG. 6 as the user continues their swiping-up browsing operation, and the historical reading progress queried by the electronic device is not empty, the electronic device may display the progress jump control 610 in the bottom area of the reading page shown in FIG. 6.

The electronic device may then detect the user's operation. If it is detected that the user has performed the trigger operation on the progress jump control 610 exemplified in FIG. 6, the electronic device may switch the display of the second book content on the reading page to the display of the book content corresponding to the historical reading progress.

In the book information processing method of the embodiment of the present disclosure, the first character card of the plurality of character cards corresponding to the target character and the first book content when the target character is at the first book stage can be displayed on the character details page corresponding to the target character. The first character card is generated based on the first book content. More information about the recommended target character at the first book stage is displayed through the character details page, which improves the content and diversity of information about the recommended character. In addition, by displaying the first book content on the character details page, content in the body of the book corresponding to the first character card is revealed in advance, so that the user may browse the character details page to determine whether they want to continue reading the target book in which the recommended character is located, thereby improving the efficiency of book selection, the success rate of recommending books in a character dimension, and the reading conversion rate of books. In addition, in response to the target interactive operation on the first book content, the reading page of the target book may be displayed, and the second book content of the target book may be displayed on the reading page, which makes it possible to directly jump to the reading page to read the book content through the interactive operation on the first book content on the character details page, improving the immersion of a jump to reading, and shortening the operation path from recommendation information on the book to the reading page, thereby further improving the reading conversion rate of the recommended book.

In some embodiments, a second character card corresponding to the target character is also displayed on the character details page. The second character card is generated based on third book content when the target character is at a second book stage, and it is another character card of the plurality of character cards corresponding to the target character that is distinct from the first character card. That is, character cards corresponding to the target character at a plurality of book stages may be displayed on the character details page, and each character card may be generated based on book content at a corresponding book stage by means of the generative model.

On the basis of the above embodiments, the book information processing method further includes: displaying the third book content on the character details page in response to the trigger operation on the second character card.

Specifically, as shown in FIG. 3, character cards, such as the first character card and the second character card, corresponding to the target character may be stacked in order or may be stacked out of order. As shown in FIG. 4, character cards such as the first character card and the second character card may also be arranged in a tiled manner in a certain direction (such as a vertical direction or a horizontal direction of the viewing direction of the device). On this basis, in order to improve the efficiency of book selection, each of the above character cards may be provided with a switching function, such as swiping switching in a direction corresponding to the arrangement of the character cards, or page flipping switching. In this way, after the user performs a switching operation on another character card, such as the second character card, the electronic device may synchronize the switching of corresponding book content. For example, content on the character details page of the first character card is replaced with content on the character details page of the switched second character card, and the third book content corresponding to the second character card is displayed on the character details page after switching. For another example, the first character card may be switched, on an original character details page, to the second character card, and the first book content may be synchronously switched to the third book content. This allows the user to select and review the book stages at which the target character is located and the book content at the stages on the character details page, further improving the efficiency of book recommendation and the efficiency of book selection.

In some embodiments, S110 may be implemented as: displaying, on the character details page, the first character card corresponding to the target character and the first book content if the target book satisfies a first condition.

The first condition comprises a book unfinished state or the presence of a historical reading progress.

Specifically, when the target book is in a serialized state of book content, or the user has a historical reading progress for the target book, the user has a greater desire to continue reading the book content. Therefore, in this case, the first character card and the first book content corresponding to the first book stage may be displayed on the character details page, to provide the user with a faster interactive way to continue reading the book content, which can further improve the user's efficiency in reading the book in combination with a seamless jump to subsequent reading pages, thereby better attracting the user to select the target book for reading, and further improving the efficiency of book selection and the success rate of book recommendation.

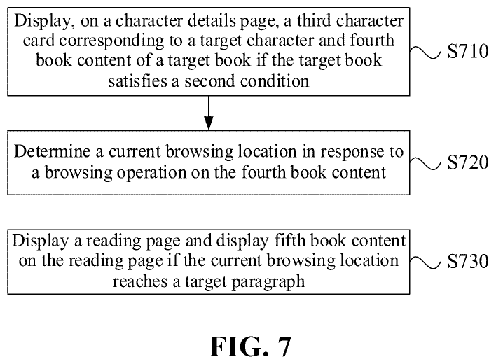

In some embodiments, FIG. 7 is a schematic flowchart of another book information processing method according to an embodiment of the present disclosure. In these embodiments, only one character card may be generated for the target book, and related content thereof may be displayed on the character details page. For the explanations of the same or similar terms or steps involved therein, reference may be made to the description of each of the above embodiments. Referring to FIG. 7, the book information processing method specifically includes the following steps.

In S710, a third character card corresponding to the target character and fourth book content of the target book are displayed on the character details page if the target book satisfies a second condition.

The second condition includes a book finished state and the absence of a historical reading progress. The third character card is generated based on content in the target book that describes the target character.

Specifically, if the target book is in the book finished state in which an update to the book content has been completed, and the user has no historical reading progress for the target book, it indicates that the target book is a brand-new finished book for the user. In this case, in order to improve the efficiency of the user understanding the target book and important characters therein, a target character may be selected from the target book, and a character card (i.e., the third character card) may be generated for the target character based on the overall information of the target book. At the same time, certain book content (that is, the fourth book content) may be determined from the target book, such as the book content of the first chapter, book content of the first few chapters, or popular book content. Afterwards, after the user triggers the third character card on the specific page, a corresponding character details page may be displayed, and a more complete third character card and the fourth book content may be displayed on the character details page.

In S720, a current browsing location is determined in response to the browsing operation on the fourth book content.

The current browsing location is a location at which the user browses the fourth book content on the character details page at a current moment. The location may be characterized by a chapter, a paragraph and a number of rows, etc. in the book, or by a location of the fourth book content in a screen area. For example, if the current browsing location may be characterized by a paragraph, the current browsing location may be represented as a current browsing paragraph.

Specifically, the user may browse the fourth book content on the character details page. During the user's browsing operation, the electronic device may obtain the current browsing location of the browsing operation in real time.

In S730, the reading page is displayed and fifth book content is displayed on the reading page if the current browsing location reaches a target paragraph.

The target paragraph is a preset critical paragraph for a page jump. The target paragraph may be determined based on paragraph information about a paragraph until which it can be determined that the user will continue reading the book. For example, the paragraph information may be a total number of paragraphs, or a combination of a number of chapters and a number of paragraphs, such as the last paragraph of the third chapter. The fifth book content is another piece of book content in the target book, which may be the book content of the first chapter of the target book, or book content of subsequent paragraphs of the target book that are continued from the target paragraph, etc.

Specifically, after obtaining the current browsing location, the electronic device may compare the current browsing location with the target paragraph. If the current browsing location reaches the target paragraph, indicating that the user is deemed to have a desire to continue reading the target book, it may be determined that the user's browsing operation has triggered a seamless page jump condition, then a jump may be made from the character details page to the reading page, and the fifth book content starts to be displayed on the reading page. In this way, an automatic jump may be made to the reading page with the user's operation of browsing a page, which maintains the consistency in the user browsing the page, improves the convenience and immersion of the user's interactive operation, further improving the user's reading efficiency, and improving the user experience.

In some embodiments, “displaying the fifth book content on the reading page” in S730 includes: if the fourth book content is content of a preset number of chapters of the target book that are sorted first, displaying, on the reading page, book content of the target book that follows the target paragraph.

The preset number is a preset number of chapters, which may be determined based on chapter information about a chapter until which it can be determined that the user will continue reading the book. For example, chapter information may be set to be 3 chapters.

Specifically, if the fourth book content on the character details page is content of a preset number of first few chapters of the book (such as the first 3 chapters of the book), the fifth book content may be set as content of a subsequent chapter of the target book that follows and is continued from the content of the preset number of chapters, in order to ensure the coherence and reading efficiency of book reading. In order to further improve the completeness of the book content and the reading consistency, the fifth book content may be determined as the book content of subsequent paragraphs of the target book that are continued from the target paragraph. In this way, subsequent book content may continue to be displayed on the reading page after the current browsing location reaches the target paragraph.

In some other embodiments, “displaying the fifth book content on the reading page” in S730 includes: if the fourth book content is preset content corresponding to the target book, displaying the book content of the first chapter of the target book on the reading page.

The preset content includes popular chapter content of the target book and/or popular plot excerpts of the target book. The popular chapters' content may be determined through the interactive data such as a number of readers, a number of comments, and a number of annotations for each chapter. The popular plot excerpt is an excerpt from a popular plot in the book, which may be determined through a degree of correlation with the main story line of the book and/or the above-mentioned interactive data.

Specifically, the fourth book content on the character details page may be set as the preset content, to attract the user to read the book with wonderful content of the target book, thereby improving the success rate of book recommendation. In this case, to ensure the completeness of the book content, the fifth book content may be set as the book content of the first chapter of the target book. For example, if the fourth book content on the character details page is the popular chapter content of the book, the book content of the first chapter of the book may be displayed after a seamless jump to the reading page, so that the user may read the book in its entirety from the beginning.

It can be understood that the fourth book content is book content selected from the target book, while the fifth book content begins with content of the first chapter of the target book, and therefore, book content following the fifth book content may include the fourth book content, to ensure the consistency in book reading.

In some embodiments, “displaying the reading page if the current browsing location reaches a target paragraph” in S730 above includes: if the current browsing location reaches the target paragraph and it is determined that an operation direction of the browsing operation remains unchanged, displaying a reading jump prompt; and displaying the reading page in response to the interactive operation corresponding to the reading jump prompt.

The reading jump prompt is prompt information for prompting the user to perform the interactive operation of making a seamless jump to the reading page.

Specifically, if the current browsing location at which the user is browsing the fourth book content on the character details page reaches the target paragraph, and the user still maintains the browsing operation in the same direction, the reading jump prompt may be displayed at a specific location on the character details page, to prompt the user how to perform the interactive operation to continue reading the book content.

For example, when the user performs a swiping-up browsing operation on the fourth book content 420 on the character details page shown in FIG. 4, all of information on the character details page moves up as a whole so that part of the fourth book content that is not displayed continues to be displayed on a viewable area of the screen, until the current browsing location reaches the target paragraph. As shown in FIG. 5, the target paragraph may be set as the last paragraph of the fourth book content. If the current browsing location reaches the last paragraph of the fourth book content, and the user continues to perform the swiping-up browsing operation as shown in FIG. 5, the reading jump prompt 510 with text content “Let go to view more content” may be displayed at the bottom of the page.

Then, if it is detected that the user has performed the interactive operation indicated by the reading jump prompt 510, such as an operation of continuing swiping-up, the electronic device may make a jump from the character details page shown in FIG. 5 to the reading page shown in FIG. 6. In this way, the convenience and success rate of the interaction of a seamless page jump are further improved.

In some embodiments, after determining the current browsing location in response to the browsing operation on the fourth book content as described above, the book information processing method further includes: if the current browsing location reaches the target paragraph and it is determined that an operation direction of the browsing operation changes in a reverse direction, displaying reading guidance information.

Specifically, if the current browsing location at which the user is browsing the fourth book content reaches the target paragraph, and the user does not continue the original browsing operation, but performs a reverse browsing operation, in order to improve the success rate of the user making a jump to the reading page, the reading guidance information may be displayed at the specific location on the character details page to guide the user to perform certain interactive operations to automatically jump to the reading page to continue reading.

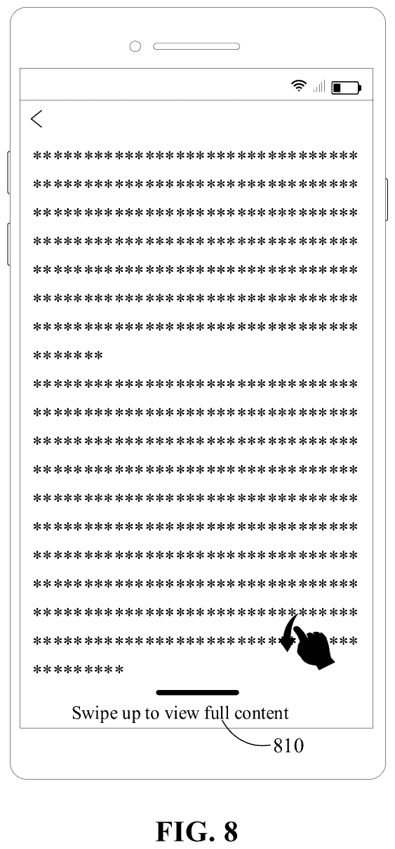

Still referring to the example of FIG. 4 in which the user performs the swiping-up browsing operation on the fourth book content 420 on the character details page shown in FIG. 4, all of the information on the character details page moves up as a whole with the browsing operation, until the current browsing location reaches the target paragraph. Similarly, the target paragraph may be set to be the last paragraph of the fourth book content. If the current browsing location reaches the last paragraph of the fourth book content, and as shown in FIG. 8, the user does not continue to perform the swiping-up browsing operation, but performs a swiping-down browsing operation, the seamless jump function may not be triggered. At this point, in order to guide the user to perform the interactive operation of the seamless page jump, the read guidance information 810 with text content “Swipe up to view full content” may be displayed at the bottom of the page. The user may follow a guidance instruction of the read guidance information 810, and then performs the swiping-up browsing operation instead.

In some embodiments, to improve the efficiency of book recommendation, character cards of a plurality of characters may be recommended to the user at the same time. After the user makes a jump from the specific page to the character details page, a recommendation function for the character cards of the plurality of characters may also be added to the character details page, to improve the efficiency of book recommendation as well. That is, other character cards of at least one other character are also displayed on the character details page.

In one example, character cards, other than the third character card, on the character details page may be character cards recommended on the specific page, and the character cards on the character details page are arranged in the same order as the character cards on the specific page.

In another example, character cards, other than the third character card, on the character details page are generated at least based on other books related to the target book and character information in the other books. In this example, considering that the third character card that the user hits may characterize the user's reading preference, the book information of the target book may be used to match other books with a high degree of relevance to the book (such as a degree of relevance reaching a certain preset threshold), in order to improve the success rate of book recommendation. Then, from characters contained in the other books, other characters with a high degree of relevance to the target character or with a high degree of popularity are selected, and other character cards are then generated based on character information of the selected other characters and book information of the other books. This can improve the degree of matching between other character cards and the user's reading preference, thus improving the success rate of recommendation and reading conversion rate for corresponding other books.

In some embodiments, if at least one other character card is also displayed on the character details page, after S710, the book information processing method further includes: in response to the switching operation on the third character card, displaying a character details page of the other character card that is in a direction of the switching operation on the third character card.

Specifically, in order to improve the efficiency of book selection, the third character card and other character cards may be provided with a switching function, such as swiping switching in a direction corresponding to the arrangement of the character cards, or page flipping switching. In this way, after the user performs the switching operation on the character cards, the electronic device may synchronously switch content on the character details page, that is, replacing content on the character details page of the third character card with content on a character details page of the switched other character card. This allows the user to select characters and books on the character details page, further improving the efficiency of book recommendation and the efficiency of book selection.

The following is an embodiment of a book information processing apparatus according to an embodiment of the present invention, the apparatus belongs to the same inventive concept as the book information processing method of the above embodiments. For details not described in detail in the embodiment of the book information processing apparatus, reference may be made to the above embodiment of the book information processing method.

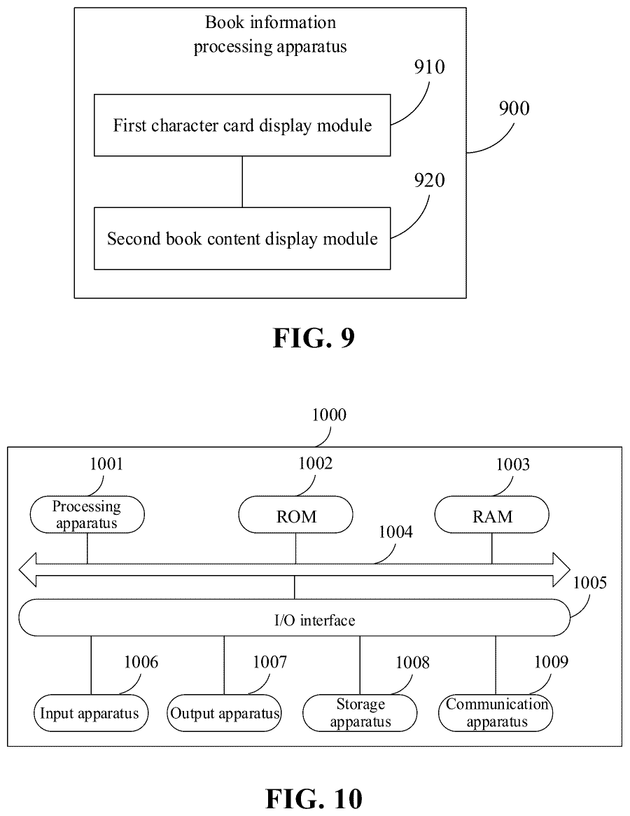

FIG. 9 is a schematic diagram of a structure of a book information processing apparatus according to an embodiment of the present disclosure. As shown in FIG. 9, the book information processing apparatus 900 may include:
a first character card display module 910 configured to display, on a character details page corresponding to a target character, a first character card corresponding to the target character and first book content when the target character is at a first book stage, where the first character card is generated based on the first book content; and the first character card is one of the plurality of character cards corresponding to the target character; and
a second book content display module 920 configured to, in response to a target interactive operation on the first book content, display a reading page of a target book in which the target character is located, and display second book content of the target book on the reading page second book content display module.

In the book information processing apparatus of the embodiment of the present disclosure, the first character card of the plurality of character cards corresponding to the target character and the first book content when the target character is at the first book stage can be displayed on the character details page corresponding to the target character. The first character card is generated based on the first book content. More information about the recommended target character at the first book stage is displayed through the character details page, which improves the content and diversity of information about the recommended character. In addition, by displaying the first book content on the character details page, content in the body of the book corresponding to the first character card is revealed in advance, so that the user may browse the character details page to determine whether they want to continue reading the target book in which the recommended character is located, thereby improving the efficiency of book selection, the success rate of recommending books in a character dimension, and the reading conversion rate of books. In addition, in response to the target interactive operation on the first book content, the reading page of the target book may be displayed, and the second book content of the target book may be displayed on the reading page, which makes it possible to directly jump to the reading page to read the book content through the interactive operation on the first book content on the character details page, improving the immersion of a jump to reading, and shortening the operation path from recommendation information on the book to the reading page, thereby further improving the reading conversion rate of the recommended book.

In some embodiments, the first character card includes a first character image of the target character, the first character image is generated based on the first book content and a target image style, and the target image style is determined based on interactive data of character images selected in a historical period of time.

In some embodiments, the first book stage includes at least one of a book stage corresponding to a first reading progress in historical reading progresses, a book stage corresponding to a first update node in book content update nodes, and a book stage corresponding to a first development node in plot development nodes of the target character.

In some embodiments, a second character card corresponding to the target character is further displayed on the character details page. The second character card is generated based on third book content when the target character is at a second book stage.

The book information processing apparatus 900 further includes a character card switching module configured to:
display the third book content on the character details page in response to a trigger operation on the second character card.

In some embodiments, the first character card display module 910 is specifically configured to:
display, on the character details page, the first character card corresponding to the target character and the first book content if the target book satisfies a first condition. The first condition comprises a book unfinished state or the presence of a historical reading progress.

In some embodiments, the book information processing apparatus 900 further includes a third character card display module configured to:
display, on the character details page, a third character card corresponding to the target character and fourth book content of the target book if the target book satisfies a second condition. The second condition includes a book finished state and the absence of a historical reading progress. The third character card is generated based on content in the target book that describes the target character.

Further, the book information processing apparatus 900 further includes:
a current browsing location determination module configured to, after displaying, on the character details page, the third character card corresponding to the target character and the fourth book content of the target book if the target book satisfies the second condition, determine a current browsing location in response to a browsing operation on the fourth book content; and a fifth book content display module configured to display the reading page and display fifth book content on the reading page if the current browsing location reaches a target paragraph.

Further, the fifth book content display module is specifically configured to: if the fourth book content is content of a preset number of chapters of the target book that are sorted first, display, on the reading page, book content of the target book that follows the target paragraph.

Optionally, the fifth book content display module is specifically configured to:
if the fourth book content is preset content corresponding to the target book, display book content of a first chapter of the target book on the reading page. The preset content includes popular chapter content of the target book and/or popular plot excerpts of the target book.

In some embodiments, the target character is determined from a plurality of candidate characters contained in the target book based on a character popularity value and a target character type. The target book is determined from a plurality of candidate books based on a book popularity value and a target book type.

Alternatively, the target character is determined from a plurality of candidate characters based on a character popularity value and a target character type. second book content display module second book content display module second book content display module

The book information processing apparatus provided in the embodiments of the present invention can perform the book information processing method provided in any embodiment of the present invention, and has corresponding functional modules and beneficial effects for performing the method.

It is worth noting that in the embodiment of the book information processing apparatus described above, the modules and sub-modules included are obtained through division merely according to functional logic, but are not limited to the above division, as long as corresponding functions can be implemented. In addition, specific names of the functional modules/sub-modules are merely used for mutual distinguishing, and are not used to limit the protection scope of the present disclosure.

An embodiment of the present disclosure further provides an electronic device. The electronic device may include a processor and a memory that may be configured to store executable instructions. The processor may be configured to read the executable instructions from the memory, and execute the executable instructions to implement the book information processing method in the above embodiments.

FIG. 10 is a schematic diagram of a structure of an electronic device according to an embodiment of the present disclosure.

As shown in FIG. 10, the electronic device 1000 may include a processing apparatus 1001 (e.g., a central processing unit, a graphics processing unit, etc.) that may perform a variety of appropriate actions and processing in accordance with a program stored in a read-only memory (ROM) 1002 or a program loaded from a storage apparatus 1008 into a random access memory (RAM) 1003. The RAM 1003 further stores various programs and data required for the operation of the electronic device 1000. The processing apparatus 1001, the ROM 1002, and the RAM 1003 are connected to each other through a bus 1004. An input/output interface (I/O interface) 1005 is also connected to the bus 1004.

Generally, the following apparatuses may be connected to the I/O interface 1005: an input apparatus 1006 including, for example, a touch screen, a touchpad, a keyboard, a mouse, a camera, a microphone, an accelerometer, and a gyroscope; an output apparatus 1007 including, for example, a liquid crystal display (LCD), a speaker, and a vibrator; the storage apparatus 1008 including, for example, a tape and a hard disk; and a communication apparatus 1009. The communication apparatus 1009 may allow the electronic device 1000 to perform wireless or wired communication with other devices to exchange data.

It should be note that, the electronic device 1000 shown in FIG. 10 is merely an example, and shall not impose any limitation on the function and scope of use of the embodiments of the present disclosure. That is, although FIG. 10 shows the electronic device 1000 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 1009 and installed, installed from the storage apparatus 1008, or installed from the ROM 1002. When the computer program is executed by the processing apparatus 1001, the above-mentioned functions defined in the book information processing method of any embodiment of the present disclosure are performed.

An embodiment of the present disclosure further provides a computer-readable storage medium storing a computer program, where the computer program, when executed by a processor, causes the processor to implement the book information processing method in any embodiment of the present disclosure.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as HTTP, and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to perform the steps of the book information processing method illustrated in any of the embodiments of the present disclosure.

In the embodiments of the present disclosure, the computer program code for performing the operations of the present disclosure may be written in one or more programming languages or a combination thereof, where the programming languages include, but are not limited to, an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving a remote computer, the remote computer may be connected to a computer of a user over any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the device, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A book information processing method, comprising:
displaying, on a character details page corresponding to a target character, a first character card corresponding to the target character and first book content when the target character is at a first book stage, wherein the first character card is generated based on the first book content; and the first character card is one of a plurality of character cards corresponding to the target character; and
in response to a target interactive operation on the first book content, displaying a reading page of a target book in which the target character is located, and displaying second book content of the target book on the reading page.

2. The method according to claim 1, wherein the first character card comprises a first character image of the target character, the first character image is generated based on the first book content and a target image style, and the target image style is determined based on interactive data of character images selected in a historical period of time.

3. The method according to claim 1, wherein the first book stage comprises at least one of a book stage corresponding to a first reading progress in historical reading progresses, a book stage corresponding to a first update node in book content update nodes, and a book stage corresponding to a first development node in plot development nodes of the target character.

4. The method according to claim 1, wherein a second character card corresponding to the target character is further displayed on the character details page; the second character card is generated based on third book content when the target character is at a second book stage; and
the method further comprises:
displaying the third book content on the character details page in response to a trigger operation on the second character card.

5. The method according to claim 1, wherein the displaying, on a character details page corresponding to a target character, a first character card corresponding to the target character and first book content when the target character is at a first book stage comprises:
displaying, on the character details page, the first character card corresponding to the target character and the first book content in response to the target book satisfying a first condition, wherein the first condition comprises a book unfinished state or the presence of a historical reading progress.

6. The method according to claim 1, wherein the method further comprises:
displaying, on the character details page, a third character card corresponding to the target character and fourth book content of the target book in response to the target book satisfying a second condition, wherein the second condition comprises a book finished state and the absence of a historical reading progress; and the third character card is generated based on content in the target book that describes the target character.

7. The method according to claim 6, wherein after the displaying, on the character details page, a third character card corresponding to the target character and fourth book content of the target book in response to the target book satisfying a second condition, the method further comprises:
determining a current browsing location in response to a browsing operation on the fourth book content; and
displaying the reading page and displaying fifth book content on the reading page in response to the current browsing location reaching a target paragraph.

8. The method according to claim 7, wherein the displaying fifth book content on the reading page comprises:
in response to the fourth book content being content of a preset number of chapters of the target book that are sorted first, displaying, on the reading page, book content of the target book that follows the target paragraph.

9. The method according to claim 7, wherein the displaying fifth book content on the reading page comprises:
in response to the fourth book content being preset content corresponding to the target book, displaying book content of a first chapter of the target book on the reading page, wherein the preset content comprises popular chapter content of the target book and/or popular plot excerpts of the target book.

10. The method according to claim 1, wherein the target character is determined from a plurality of candidate characters contained in the target book based on a character popularity value and a target character type; and the target book is determined from a plurality of candidate books based on a book popularity value and a target book type;
or the target character is determined from a plurality of candidate characters based on a character popularity value and a target character type.

11. An electronic device, comprising:
a processor; and
a memory configured to store executable instructions,
wherein the processor is configured to read the executable instructions from the memory, and the executable instructions, when executed by the processor, cause the electronic device to:
display, on a character details page corresponding to a target character, a first character card corresponding to the target character and first book content when the target character is at a first book stage, wherein the first character card is generated based on the first book content; and the first character card is one of a plurality of character cards corresponding to the target character; and
in response to a target interactive operation on the first book content, display a reading page of a target book in which the target character is located, and display second book content of the target book on the reading page.

12. The electronic device according to claim 11, wherein the first character card comprises a first character image of the target character, the first character image is generated based on the first book content and a target image style, and the target image style is determined based on interactive data of character images selected in a historical period of time.

13. The electronic device according to claim 11, wherein the first book stage comprises at least one of a book stage corresponding to a first reading progress in historical reading progresses, a book stage corresponding to a first update node in book content update nodes, and a book stage corresponding to a first development node in plot development nodes of the target character.

14. The electronic device according to claim 11, wherein a second character card corresponding to the target character is further displayed on the character details page; the second character card is generated based on third book content when the target character is at a second book stage; and
the executable instructions further cause the electronic device to:
display the third book content on the character details page in response to a trigger operation on the second character card.

15. The electronic device according to claim 11, wherein the executable instructions causing the electronic device to display, on a character details page corresponding to a target character, a first character card corresponding to the target character and first book content when the target character is at a first book stage further cause the electronic device to:
display, on the character details page, the first character card corresponding to the target character and the first book content in response to the target book satisfying a first condition, wherein the first condition comprises a book unfinished state or the presence of a historical reading progress.

16. The electronic device according to claim 11, wherein the executable instructions further cause the electronic device to:
display, on the character details page, a third character card corresponding to the target character and fourth book content of the target book in response to the target book satisfying a second condition, wherein the second condition comprises a book finished state and the absence of a historical reading progress; and the third character card is generated based on content in the target book that describes the target character.

17. The electronic device according to claim 16, wherein after the executable instructions causing the electronic device to display, on the character details page, a third character card corresponding to the target character and fourth book content of the target book in response to the target book satisfying a second condition, the executable instructions further cause the electronic device to:
determine a current browsing location in response to a browsing operation on the fourth book content; and
display the reading page and display fifth book content on the reading page in response to the current browsing location reaching a target paragraph.

18. The electronic device according to claim 17, wherein the executable instructions causing the electronic device to display fifth book content on the reading page further cause the electronic device to:
in response to the fourth book content being content of a preset number of chapters of the target book that are sorted first, display, on the reading page, book content of the target book that follows the target paragraph.

19. The electronic device according to claim 17, wherein the executable instructions causing the electronic device to display fifth book content on the reading page further cause the electronic device to:
in response to the fourth book content being preset content corresponding to the target book, display book content of a first chapter of the target book on the reading page, wherein the preset content comprises popular chapter content of the target book and/or popular plot excerpts of the target book.

20. A non-transitory computer-readable storage medium, storing a computer program, wherein the computer program, when executed by a processor, causes the processor to:
display, on a character details page corresponding to a target character, a first character card corresponding to the target character and first book content when the target character is at a first book stage, wherein the first character card is generated based on the first book content; and the first character card is one of a plurality of character cards corresponding to the target character; and
in response to a target interactive operation on the first book content, display a reading page of a target book in which the target character is located, and display second book content of the target book on the reading page.
